(19) United States
(12) Patent Application Publication
(10) Pub. No.: US 2009/0102824 A1
(43) Pub. Date: Apr. 23, 2009

(54) ACTIVE MATRIX SUBSTRATE AND DISPLAY DEVICE USING THE SAME

(75) Inventors: Shinya Tanaka, Mie (JP); Yoshiharu Kataoka, Mie (JP); Hajime Imai, Mie (JP); Masaya Okamoto, Kyoto (JP); Chikanori Tsukamura, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka (JP)

(21) Appl. No.: 12/282,673

(22) PCT Filed: Mar. 13, 2007
(86) PCT No.: PCT/JP2007/054870

§ 371 Date: Sep. 12, 2008

(30) Foreign Application Priority Data
Mar. 15, 2006 (JP) 2006-071528

(51) Int. Cl. G09G 3/30; G06F 3/038

(52) U.S. Cl. 345/205; 345/55

(57) ABSTRACT

In an odd-shaped display whose display area is not rectangular in shape, a defect such as a reduction in the display quality due to the bright line or the like caused by the pixels that are located in a specific portion can be prevented. In an active matrix substrate used as a substrate of such an odd-shaped display in which the distribution area of the pixel electrodes corresponding to the display area has a shape other than rectangular, at least one dummy gate line is formed outside the gate line that is located at the outermost edge on the scanning start side. For peripheral pixels connected to the gate line and the gate line that lies on the scanning end side of the gate line, the gate lines located one row above the respective gate lines are extended on the opposite side of each of the peripheral pixels from the gate line to which the TFT of each of the peripheral pixels is connected. It is preferable that dummy pixels are located on the upper side of the individual peripheral pixels.

### BACKGROUND OF THE INVENTION

1. Field of the Invention

The present invention relates to an active matrix substrate on which switching elements such as thin film transistors are arranged in a matrix, and a display device using the active matrix substrate.

2. Description of the Related Art

Conventionally, there has been known a so-called active matrix liquid crystal display device including an active matrix substrate on which switching elements such as thin film transistors (TFTs) are arranged in a matrix.

The configurations of a conventional active matrix substrate and a liquid crystal display device including the same will be described with reference to FIGS. 6 to 10. FIG. 6 is an equivalent circuit diagram showing the configuration of the conventional active matrix substrate. FIG. 7 is a plan view showing the configuration of a pixel of the active matrix substrate shown in FIG. 6. FIG. 8 is a cross-sectional view taken along the line A-A′ in FIG. 7. FIG. 9 is an equivalent circuit diagram showing the ideal state of a pixel in the liquid crystal display device shown in FIG. 8. FIG. 10 is an equivalent circuit diagram of capacitances generated in the actual state of a pixel.

As shown in FIG. 8, the conventional active matrix liquid crystal display device has a configuration in which a liquid crystal 2 is sealed between a pair of upper and lower transparent glass substrates 1a and 1b. Generally, the glass substrate 1a is referred to as an active matrix substrate and the glass substrate 1b is referred to as a counter substrate. As shown in FIGS. 6 to 8, gate lines G₁, G₂, . . . and source lines S₁, S₂, . . . , each of which is made of a transparent conductive film, are disposed at right angles on the glass substrate 1a. Thin film transistors (referred to as TFTs in the following) 5 that serve as switching elements are provided in the vicinity of the individual intersections of the gate lines G₁, G₂, . . . and the source lines S₁, S₂, . . . Transparent pixel electrodes 6 are connected to each of the TFTs 5. A gate driver K applies scanning signals to the gate lines G₁, G₂, . . . in sequence. A data driver L applies data signals to the source lines S₁, S₂, . . . in sequence. In FIG. 8, reference numeral 20 denotes a gate insulating film, and reference numerals 22 and 23 denote an i layer and an n⁺ layer of amorphous Si, respectively.

The glass substrate 1b is provided with a common electrode 7 made of a transparent conductive film and a color filter 8. The common electrode 7 is connected to a common line 9 to which a common signal is applied. In the color filter 8, color filters of three primary colors of R, G and B are arranged regularly so as to correspond to each of the pixel electrodes 6. A polarizer (not shown) is located on the outer side of each of the glass substrates 1a, 1b. As shown in FIG. 9, the pixel electrode 6 and the common electrode 7 constitute a capacitor 12 for providing a liquid crystal capacitance C_{LC}.

The gate electrodes 5g, source electrodes 5s, and drain electrodes 5d of the TFTs 5 are connected to the gate lines G₁, G₂, . . . , the source lines S₁, S₂, . . . , and the pixel electrodes 6, respectively. Moreover, subsidiary capacitance lines 10 made of a transparent conductive film are formed in a lower portion of each of the pixel electrodes 6, as shown in FIG. 7, and the subsidiary capacitance lines 10 are connected to the common line 9. From the viewpoint of improving the retentivity of the liquid crystal 2 to achieve high image quality, the pixel electrode 6 and the subsidiary capacitance line 10 constitute a capacitor 13 for providing a subsidiary capacitance C_{S}.

With this configuration, when the scanning signals are input to the gate lines G₁, G₂, . . . sequentially downward by the gate driver K in this example, all the gates of the TFTs 5 connected to one gate line are turned on at the same time due to the input of the scanning signal, and then the data signals for display are input to each of the pixels corresponding to this gate line from the source lines S₁, S₂, . . . by the data driver L. Thus, the data signals are applied to the pixel electrodes 6, and the transmittance of the liquid crystal 2 varies with a potential difference between each of the pixel electrodes 6 and the common electrode 7, thereby achieving a gradation display in accordance with the data signals.

In this case, if a direct voltage continues to be applied to the liquid crystal 2 for a long time, the retention characteristics of the liquid crystal 2 are degraded. Therefore, so-called AC drive is performed in such a manner that the positive and negative voltages are applied alternately to the pixel electrodes 6, e.g., by reversing the polarities of the data signals input to the source lines S₁, S₂, . . . in each cycle of the horizontal period.

Generally, when the conductive films are arranged in parallel or located one upon another with an insulating film between them, a parasitic capacitance is generated between the conductive films. In the ideal state of a pixel, as shown in FIG. 9, there exist only the liquid crystal capacitance C_{LC} between the pixel electrode 6 and the common electrode 7 and the subsidiary capacitance C_{S} between the pixel electrode 6 and the subsidiary capacitance line 10. However, regarding, e.g., a pixel located in the second row and the first column (namely, the pixel in which the gate of the TFT 5 is connected to the second gate line G₂ from the top, and the source of the TFT 5 is connected to the first source line S₁ from the left), the pixel electrode 6 is surrounded by the upper and lower gate lines G₁, G₂ and the left and right source lines S₁, S₂, as shown in FIG. 7. Thus, parasitic capacitances Csd₁, Csd₂, Cgd₁, and Cgd₂ are generated between the pixel electrode 6 and the respective lines G₁, G₂, S₁, and S₂, as shown in FIG. 10.

In this case, a parasitic capacitance ratio α is expressed by the following equation (1).

α=ΔC/(C_{LC}+Cₛ+ΔC), where ΔC=Cgd₁+Cgd₂ (1)

For the AC drive of the liquid crystal 2 as described above, such a parasitic capacitance ratio α affects a fluctuation ΔV in the voltage applied to the pixel electrode 6, and the voltage fluctuation ΔV causes a DC component, resulting in degraded retention characteristics. Thus, to prevent the generation of a DC component, the optimization has been conventionally performed for each gradation of the data signals in accordance with the parasitic capacitance ratio α.

The parasitic capacitances generated in each pixel have been described with reference to one pixel in which the TFT 5 is connected to the second gate line G₂ from the top. Next, regarding another pixel in which the TFT 5 is connected to the topmost gate line G₁ from which the scanning signal starts to scan, no gate line is present above the pixel electrode 6 constituting this pixel. Accordingly, the parasitic capacitance Cgd₂ is not generated. In such a case, a parasitic capacitance ratio α′ is expressed by the following equation (2).

α′=ΔC′/(C_{LC}+Cₛ+ΔC′), where ΔC′=Cgd₁ (2)

Each of the pixels corresponding to the gate lines G₂, G₃, . . . in the second and the following rows is vertically symmetrical, and thus has a parasitic capacitance ratio α given by the equation (1). On the other hand, each of the pixels corresponding to the gate line G₁ in the topmost row is not vertically symmetrical, and thus has a parasitic capacitance ratio α′ given by the equation (2). That is, the pixels corresponding to the topmost gate line and the pixels corresponding to the second and the following gate lines differ in their parasitic capacitance ratios (α and α′).

As described above, in the pixels corresponding to the second and the following gate lines G₂, G₃, . . . , the application of the DC component to the liquid crystal 2 can be prevented by performing the optimization to reduce the influence of the parasitic capacitance ratio α. However, the pixels corresponding to the topmost gate line G₁ have the parasitic capacitance ratio α′ different from that in the other pixel portions, so that the fluctuation ΔV in the voltage applied to the pixel electrodes 6 cannot be eliminated. Accordingly, unlike the second and the following gate lines G₂, G₃, . . . , a small DC component is applied to the liquid crystal 2 of the pixels corresponding to the topmost gate line G₁.

When such a DC component is applied, the retention characteristics of the liquid crystal 2 are degraded gradually over time. Consequently, the pixels corresponding to the topmost gate line G₁ may impair the display quality, e.g., by causing a bright line in the halftone display while the liquid crystal 2 is in the normally white mode or by causing a black line in the halftone display while the liquid crystal 2 is in the normally black mode (these phenomena are generically called “bright line or the like” in the following). These phenomena occur more considerably when a driving operation is conducted at high temperatures in particular.

In order to solve this problem, as shown in FIG. 11, JP H09-288260 A discloses an active matrix substrate having a configuration in which a dummy gate line G₀ for forming capacitances is provided outside the gate line G₁ located at the outermost edge on the scanning start side. With this configuration, the presence of the dummy gate line G₀ for forming capacitances makes the parasitic capacitances generated in the pixels corresponding to the topmost gate line G₁ equal to those generated in the pixels corresponding to the second and the following gate lines G₂, G₃, . . . , and thus the bright line or the like can be prevented.

In recent years, the applications of thin displays have been increasingly diversified as the thin displays become widely available. For example, a liquid crystal display device may be used for an instrumental panel or the like of a car. In such an application, instead of a conventional general display device having a rectangular screen, odd-shaped displays having circular, semicircular, elliptic, triangular, or polygonal (with five sides or more) screens may be used. In this specification, the term “odd-shaped display” refers to a display whose display area can be of any shape other than rectangular.

### SUMMARY OF THE INVENTION

In order to overcome the problems described above, preferred embodiments of the present invention provide an active matrix substrate capable of preventing a defect such as a reduction in the display quality due to the bright line or the like caused by the pixels that are located in a specific portion, even in the case of the odd-shaped display as described above. Moreover, preferred embodiments of the present invention provide an active matrix display device capable of displaying high quality images by using such a novel active matrix substrate.

An active matrix substrate according to a preferred embodiment of the present invention is used as a substrate of a display device and includes the following: a plurality of gate lines to which scanning signals are applied; a plurality of source lines to which data signals are applied, the source lines being disposed at right angles to the gate lines; switching elements that are located in the vicinity of the individual intersections of the gate lines and the source lines where each of the switching elements is connected to both the gate line and the source line; and pixel electrodes that are connected to the switching elements. A distribution area of the pixel electrodes corresponding to a display area of the display device has a shape other than rectangular. At least one dummy gate line is formed outside the gate line that is located at the outermost edge on the scanning start side of the gate lines in the distribution area. Among peripheral pixels located on the perimeter of the distribution area, when the gate line that is located at the outermost edge on the scanning start side of the gate lines is identified as a first gate line, the peripheral pixel connected to the nth gate line (n is an integer of 2 or more) is interposed between the nth gate line and the (n−1)th gate line that is extended on the opposite side of the peripheral pixel from the gate line to which the switching element of the peripheral pixel is connected.

According to another preferred embodiment of the present invention, a display device the active matrix substrate according to the above-described preferred embodiment of the present invention.

As described above, various preferred embodiments of the present invention can provide an active matrix substrate capable of preventing a defect such as a reduction in the display quality due to the bright line or the like caused by the pixels that are located in a specific portion, even in the case of an odd-shaped display. Moreover, various preferred embodiments of the present invention can provide an active matrix display device capable of displaying high quality images by using the active matrix substrate.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an equivalent circuit diagram showing the configuration of an active matrix substrate according to a preferred embodiment of the present invention.

FIG. 2 is a plan view showing an example of the appearance of a liquid crystal display device including the active matrix substrate in FIG. 1.

FIG. 3 is a waveform diagram showing an example of signals applied to dummy gate lines.

FIG. 4 is an equivalent circuit diagram showing the configuration of an active matrix substrate according to a preferred embodiment of the present invention.

FIGS. 5A and 5B are plan views, each showing an example of the shape of a display area of a display device according to a preferred embodiment of the present invention.

FIG. 6 is an equivalent circuit diagram showing the configuration of an active matrix substrate included in a conventional liquid crystal display device.

FIG. 7 is a plan view showing the configuration of a pixel of the active matrix substrate shown in FIG. 6.

FIG. 8 is a cross-sectional view showing the configuration of a conventional liquid crystal display device, taken along the line A-A′ in FIG. 7.

FIG. 9 is an equivalent circuit diagram showing the ideal state of a pixel in the conventional liquid crystal display device shown in FIG. 8.

FIG. 10 is an equivalent circuit diagram of capacitances generated in the actual state of a pixel in the conventional liquid crystal display device shown in FIG. 8.

FIG. 11 is an equivalent circuit diagram showing the configuration of a conventional active matrix substrate.

### DETAILED DESCRIPTION OF THE PREFERRED EMBODIMENTS

An active matrix substrate according to a preferred embodiment of the present invention is used as a substrate of a display device and includes the following: a plurality of gate lines to which scanning signals are applied; a plurality of source lines to which data signals are applied, the source lines being disposed at right angles to the gate lines; switching elements that are located in the vicinity of the individual intersections of the gate lines and the source lines where each of the switching elements is connected to both the gate line and the source line; and pixel electrodes that are connected to the switching elements. A distribution area of the pixel electrodes corresponding to a display area of the display device has a shape other than rectangular. At least one dummy gate line is formed outside the gate line that is located at the outermost edge on the scanning start side of the gate lines in the distribution area. Among peripheral pixels located on the perimeter of the distribution area, when the gate line that is located at the outermost edge on the scanning start side of the gate lines is identified as a first gate line, the peripheral pixel connected to the nth gate line (n is an integer of 2 or more) is interposed between the nth gate line and the (n−1)th gate line that is extended on the opposite side of the peripheral pixel from the gate line to which the switching element of the peripheral pixel is connected.

With the above configuration, the presence of the dummy gate line allows the parasitic capacitances to be generated equally in the pixels that are located on the scanning end side with respect to the dummy gate line. Therefore, a defect such as a reduction in the display quality due to the bright line or the like caused by the pixels that are located in a specific portion can be suppressed. Moreover, when the gate line that is located at the outermost edge on the scanning start side of the gate lines is identified as a first gate line, the peripheral pixel connected to the nth gate line (n is an integer of 2 or more) is interposed between the nth gate line and the (n−1)th gate line that is extended on the opposite side of the peripheral pixel from the gate line to which the switching element of the peripheral pixel is connected. Thus, even in the case of a so-called odd-shaped display, in which the distribution area of the pixel electrodes corresponding to the display area has a shape other than rectangular, it is possible to prevent a reduction in the display quality due to the bright line or the like caused by the peripheral pixels.

In the above active matrix substrate, it is preferable that dummy pixels are provided outside the dummy gate line, and each of the dummy pixels includes at least a switching element connected to the dummy gate line and a pixel electrode connected to the switching element.

In the above active matrix substrate, it is preferable that a dummy gate line is further provided outside the dummy pixels.

A display device according to a preferred embodiment of the present invention includes the above active matrix substrate. Thus, even in the case of a so-called odd-shaped display, in which the distribution area of the pixel electrodes corresponding to the display area has a shape other than rectangular, it is possible to prevent a reduction in the display quality due to the bright line or the like caused by the peripheral pixels.

It is preferable that the above display device further includes a gate driver for applying signals to the gate lines and the dummy gate lines.

In the above display device, it is preferable that the signals input to the dummy gate lines by the gate driver differ from those to be applied to each of the gate lines. Moreover, it is preferable that the signals input to the dummy gate lines by the gate driver have a voltage level at which the switching elements are not turned on. Alternatively, it is preferable that the signals input to the dummy gate lines by the gate driver have the same voltage level as scanning signals to be applied to each of the gate lines, and are applied to the dummy gate lines a predetermined time earlier than the scanning signal to be applied to the gate line that is located at the outermost edge on the scanning start side of the gate lines.

Alternatively, in the above display device, the dummy gate lines may be connected to any of the gate lines. Moreover, it is preferable that the dummy gate lines are connected to the gate line that is located at the outermost edge on the scanning start side or the gate line that is located at the outermost edge on the scanning end side of the gate lines.

Alternatively, the above display device further may include a counter substrate that is located opposite to the active matrix substrate and provided with a common electrode. It is also preferable that the dummy gate lines are connected to a common line for applying a common signal to the common electrode.

Hereinafter, an active matrix substrate according to a preferred embodiment of the present invention and a display device including the active matrix substrate will be described more specifically with reference to the drawings.

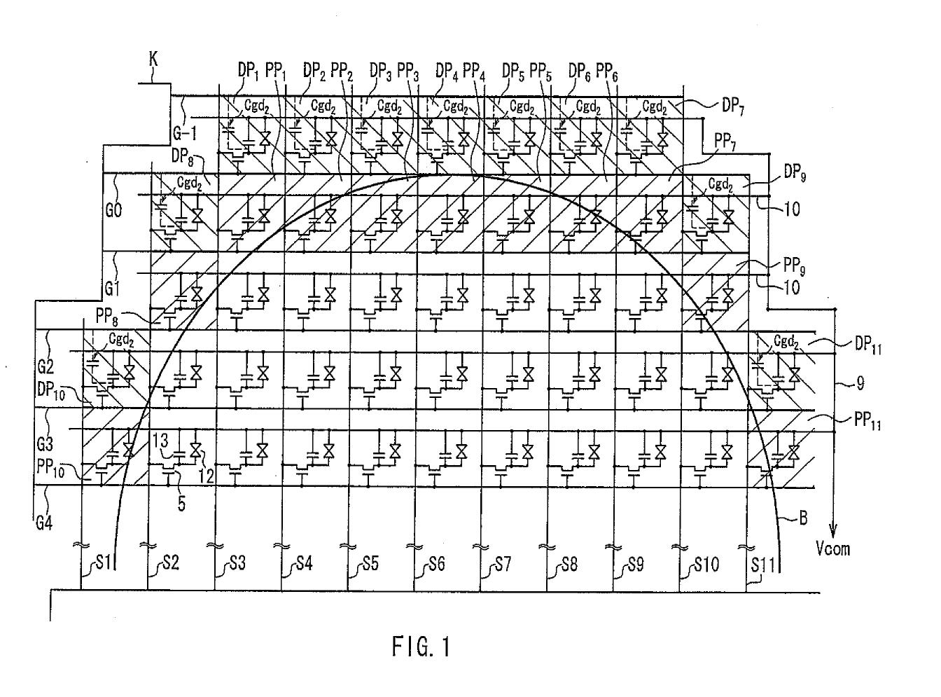

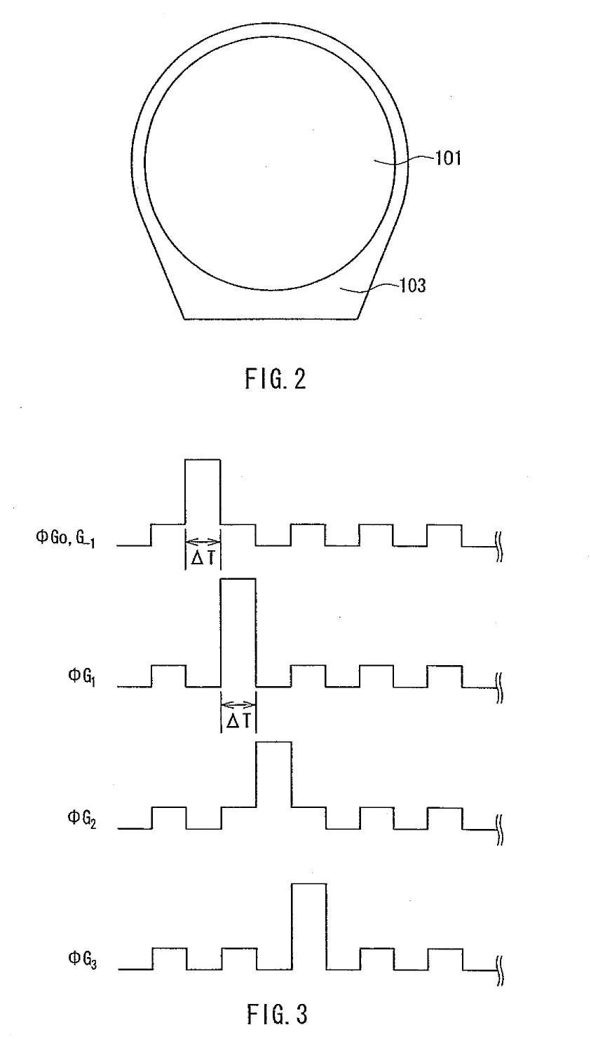

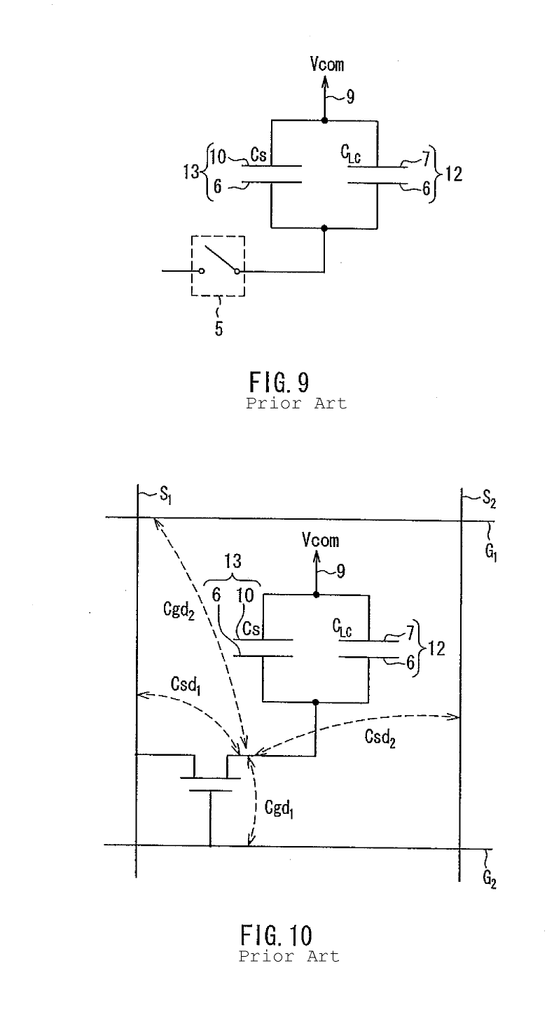

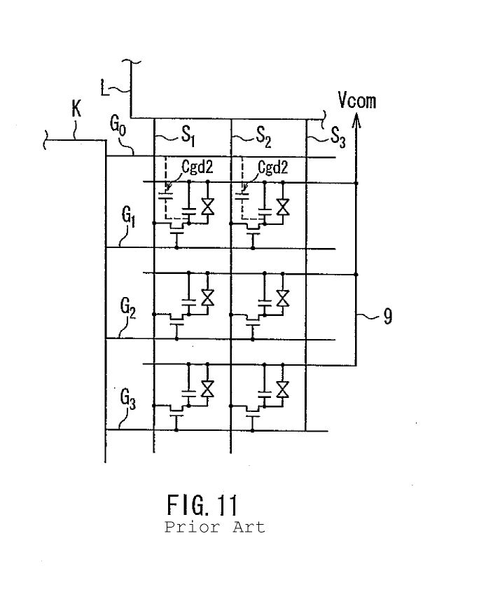

FIG. 1 is an equivalent circuit diagram showing the configuration of the active matrix substrate according to a preferred embodiment of the present invention. FIG. 2 is a plan view showing the appearance of a liquid crystal display device including the active matrix substrate in FIG. 1. The components that are similar to those in the conventional configuration shown in FIGS. 6 to 11 are denoted by the same reference numerals, and a detailed description thereof will not be repeated.

In FIG. 1, for the sake of convenience in illustration, each pixel appears larger than actual size. That is, in the actual liquid crystal display device, the number of pixels in the horizontal and vertical directions is far greater than the number of pixels shown in FIG. 1.

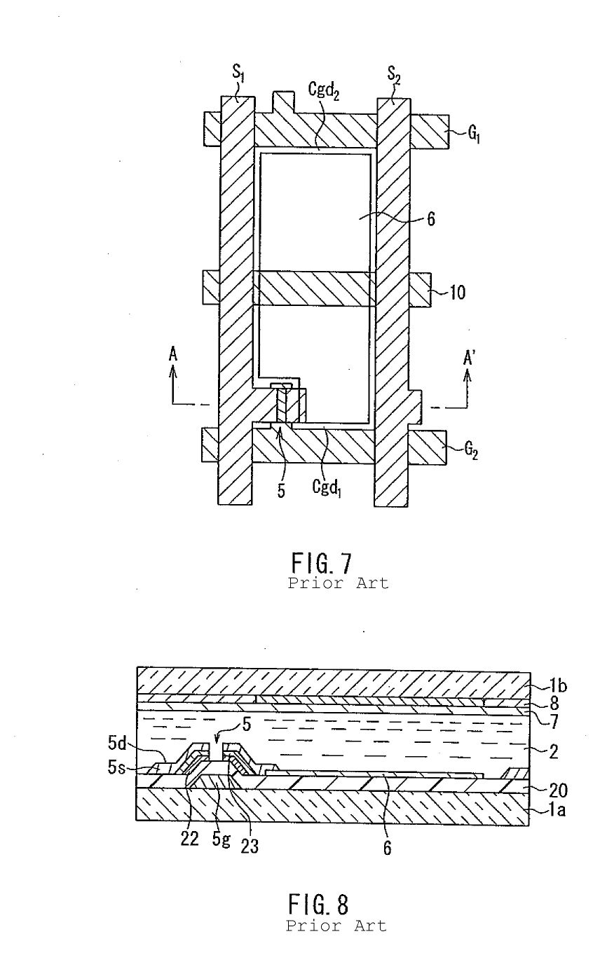

As shown in FIG. 2, the active matrix liquid crystal display device according to this preferred embodiment is preferably an odd-shaped display with a circular or substantially circular screen (display area) 101, for example. As shown in FIG. 8, the liquid crystal display device has a configuration in which a liquid crystal 2 is sealed between a pair of upper and lower transparent glass substrates 1a and 1b.

As shown in FIG. 1, in the active matrix substrate of this preferred embodiment, gate lines G₁, G₂, . . . and source lines S₁, S₂, . . . , each of which is made of a transparent conductive film, are disposed at right angles on the glass substrate 1a. TFTs 5 that serve as switching elements are provided in the vicinity of the individual intersections of the gate lines G₁, G₂, . . . and the source lines S₁, S₂, . . . Transparent pixel electrodes 6 are connected to each of the TFTs 5. A gate driver K applies scanning signals to the gate lines G₁, G₂, . . . in sequence. A data driver L applies data signals to the source lines S₁, S₂, . . . in sequence. This embodiment shows a specific example in which the scanning signals are applied to the gate lines G₁, G₂, . . . in sequence. However, the timing of the application of the scanning signals to the gate lines G₁, G₂, . . . is not limited to the specific example, and the scanning signals may be applied simultaneously to a plurality of gate lines or may be applied, e.g., to every other line.

The gate electrodes, source electrodes, and drain electrodes of the TFTs 5 are connected to the gate lines G₁, G₂, . . . , the source lines S₁, S₂, . . . , and the pixel electrodes 6, respectively. Moreover, subsidiary capacitance lines 10 made of a transparent conductive film are formed in a lower portion of each of the pixel electrodes 6, as shown in FIG. 7, and the subsidiary capacitance lines 10 are connected to the common line 9, as shown in FIG. 1. From the viewpoint of improving the retentivity of the liquid crystal 2 to achieve high image quality, the pixel electrode 6 and the subsidiary capacitance line 10 constitute a capacitor 13 for providing a subsidiary capacitance C_{S}. As shown in FIG. 1, the common line 9 that connects the subsidiary capacitance line 10 to the counter substrate is wired stepwise along the contour of the display area.

With this configuration, when the scanning signals are input to the gate lines G₁, G₂, . . . sequentially downward by the gate driver K in this example, all the gates of the TFTs 5 connected to one gate line are turned on at the same time due to the input of the scanning signal, and then the data signals for display are input to each of the pixels corresponding to this gate line from the source lines S₁, S₂, . . . by the data driver L. Thus, the data signals are applied to the pixel electrodes 6, and the transmittance of the liquid crystal 2 varies with a potential difference between each of the pixel electrodes 6 and the common electrode 7, thereby achieving a gradation display in accordance with the data signals.

A display area boundary B shown in FIG. 1 indicates a boundary between the inside and the outside of the display area of the active matrix substrate of the liquid crystal display device. The outside of the display area boundary B is covered with a black matrix (not shown). The liquid crystal display device shown in FIG. 2 includes the screen 101 and a frame portion 103 containing the drivers or the like. The shape and size of the frame portion 103 are not limited to those shown in FIG. 2.

As shown in FIG. 1, the display area boundary B does not necessarily coincide with the boundary of the pixels. When at least a portion of the pixel electrode 6 of the pixel is included in the display area, this pixel is identified as a pixel within the display area to which the data signal is applied (referred to as a “pixel within the display area” in the following). In FIG. 1, the pixels that are located within the display area and also on the perimeter of the display area (referred to as “peripheral pixels” in the following and represented by PP in the figure) are hatched with backward diagonals.

As described above, the gate driver K applies the scanning signals to the gate lines G₁, G₂, G₃, . . . on the active matrix substrate in the indicated order. That is, the gate line G₁ is located at the outermost edge on the scanning start side of this active matrix substrate.

As shown in FIG. 1, on the active matrix substrate of this preferred embodiment, dummy gate lines G₀ and G₋₁ for forming capacitances are provided further above the gate line located at the outermost edge on the scanning start side (i.e., the gate line G₁ in this example) and are disposed in parallel to the gate line G₁. Both spaces between the gate line G₁ and the dummy gate line G₀ and between the dummy gate line G₀ and the dummy gate line G₋₁ are the same as those between each of the gate lines G₁, G₂, G₃, . . . .

Dummy pixels DP₁ to DP₇ for forming capacitances are provided in the region between the dummy gate lines G₀ and G₋₁ so as to be connected to the dummy gate line G₀. Similarly to the pixels within the display area, each of the dummy pixels also includes the TFT 5, the pixel electrode 6, the subsidiary capacitance line 10, etc.

For the peripheral pixels PP₈ to PP₁₁ connected to the gate line G₂ and the gate line that lies on the lower side of the gate line G₂, the gate lines located one row above the respective gate lines are extended to cover the upper side of each of these peripheral pixels. In this case, the “lower side” indicates a position on the lower side in the screen, i.e., the scanning end side and the “upper side” indicates a position on the upper side in the screen, i.e., the scanning start side. For example, in the case of the peripheral pixel PP₈ connected to the gate line G₂, the gate line G₁ is extended to cover the upper side of the peripheral pixel PP₈. Moreover, dummy pixels DP₈ to DP₁₁ for forming capacitances are located on the upper side of the individual peripheral pixels PP₈ to PP₁₁. Similarly, the gate lines (or dummy gate lines) located one row above the respective gate lines for the dummy pixels DP₈ to DP₁₁ are extended to cover the upper side of each of the dummy pixels. For example, the gate line G₂ is extended to cover the upper side of the dummy pixel DP₁₀.

In FIG. 1, the peripheral pixels PP₁ to PP₁₁ are in one-to-one correspondence with the dummy pixels DP₁ to DP₁₁ that are located on the upper side of the individual peripheral pixels. However, two or more dummy pixels may be provided on the upper side of the individual peripheral pixels. In FIG. 1, the dummy pixels are hatched with forward diagonals.

In the configuration in FIG. 1, each of the peripheral pixels has at least one dummy gate line or extended portion of the gate line on the upper side thereof. Therefore, a parasitic capacitance C_{gd2} is generated between the pixel electrode 6 of each of the peripheral pixels and the dummy gate line or the gate line located on the upper side of the pixel electrode 6 (see FIG. 1). Although FIG. 1 shows the parasitic capacitances C_{gd2} only for the dummy pixels, the parasitic capacitances C_{gd2} also are generated in the peripheral pixels similarly to the dummy pixels. Consequently, the parasitic capacitance ratios of all the pixels are equal to the value α given by the equation (1), thus eliminating a difference in the parasitic capacitance ratio between the pixels.

The dummy gate lines G₀, G₋₁ either may be maintained at a predetermined electric potential without particularly receiving a signal, or may receive a scanning signal having a level at which the TFTs 5 connected to the dummy gate lines G₀, G₋₁ are not turned on.

Alternatively, as shown in FIG. 3, it is also preferable to design the gate driver K so that signals φG₀, φG₋₁ having the same waveform and time difference ΔT as the scanning signals φG₁, φG₂, φG₃, . . . are produced and input to the dummy gate lines G₀, G₁ before the output timing of the scanning signal φG₁ to the gate line G₁. In this manner, the parasitic capacitance conditions of all the dummy pixels and the peripheral pixels become the same as those of the other pixels within the display area as long as the optimization is performed in accordance with the parasitic capacitance ratio α of the pixels within the display area. Thus, it is possible to prevent a phenomenon in which, e.g., the peripheral pixels cause a bright line in the normally white mode or a black line in the normally black mode.

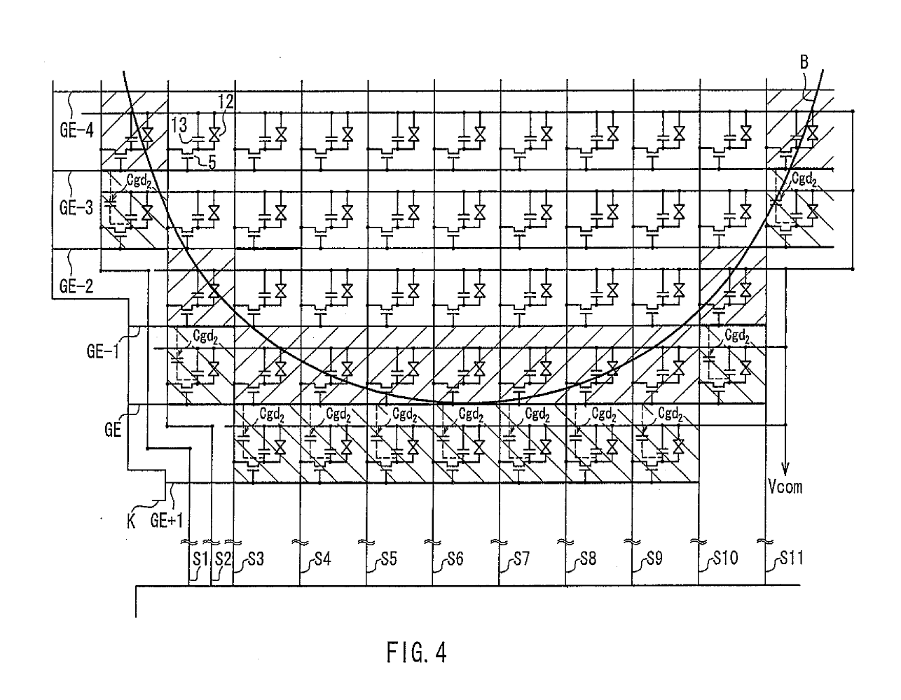

Alternatively, the dummy gate lines G₀, G₋₁ may be connected to the bottommost gate line G_{E} (see FIG. 4), thereby allowing a scanning signal φG_{E} input to the bottommost gate line G_{E} to be input directly to the dummy gate lines G₀, G₋₁. With this configuration, the existing scanning signal φG_{E} can be used, even if the gate driver K is not designed to produce specific scanning signals φG₀, φG₋₁ to the dummy gate lines G₀, G₁, as described above. Moreover, the scanning signal φG_{E} has the smallest deviation from the output timing of the scanning signal φG₁ applied to the topmost gate line G₁. Therefore, the conditions of the pixels driven by the topmost gate line G₁ are substantially the same as those of the pixels driven by the other gate lines G₂, G₃, . . . , so that a phenomenon of the bright line or the like caused by the pixels corresponding to the gate line G₁ can be suppressed sufficiently.

Alternatively, the dummy gate lines G₀, G₋₁ may be connected to the common line 9. With this configuration, a common signal Vcom applied to the common line 9 is input directly to the dummy gate lines G₀, G₋₁. In other words, the common signal Vcom whose levels are reversed in each cycle of the horizontal period (1H) is input simultaneously not only to the common electrode 7 and the subsidiary capacitance line 10 via the common line 9 so as to perform AC drive of the liquid crystal 2, but also to the dummy gate lines G₀, G₁. This configuration can use the existing common signal Vcom, and thus does not have to make any special modification to the design of the gate driver K.

Alternatively, the dummy gate lines G₀, G₋₁ may be connected to one of the gate lines G₁, G₂, . . . (e.g., the gate line G₂ in the second row). This configuration also can use the existing scanning signal, and thus does not have to make any special modification to the design of the gate driver K.

Any data signals may be applied to the dummy pixels while the scanning signal is applied to the gate line or dummy gate line to which those dummy pixels are connected. This is because the dummy pixels are covered with a black matrix and have no effect on display.

In the above configuration, for the peripheral pixels PP₁ to PP₇ connected to the gate line G₁, two dummy gate lines G₀, G₋₁ are preferably disposed on the upper side of these peripheral pixels PP₁ to PP₇. Moreover, for the peripheral pixels PP₈ to PP₉ connected to the gate line G₂, the gate line G₁ and the dummy gate line G₀ are preferably disposed on the upper side of these peripheral pixels PP₈ to PP₉. Further, for the peripheral pixels PP₁₀ to PP₁₁ connected to the gate line G₄, the gate lines G₂ and G₃ are preferably disposed on the upper side of these peripheral pixels PP₁₀ to PP₁₁. That is, a total of two lines selected from combinations of at least one of the gate lines and the dummy gate lines are preferably disposed on the upper side of the individual peripheral pixels. However, if there is at least one gate line or dummy gate line on the upper side of the peripheral pixels, parasitic capacitances C_{gd2} are generated between this gate line and each of the peripheral pixels. Thus, the effect of preventing the bright line or the like can be obtained.

In the above description, at least one dummy pixel DP is preferably located on the upper side of the individual peripheral pixels PP. However, if there is a gate line or dummy gate line on the upper side of the peripheral pixels, parasitic capacitances C_{gd2} are generated between this gate line and the pixel electrode of each of the peripheral pixels. Therefore, the dummy pixel is not necessarily required.

In the liquid crystal display device of the above preferred embodiment, when the scanning direction of the gate lines G can be switched in two ways, namely from the upper to the lower side of the screen and vice versa, it is preferable that a dummy gate line G_{E+1} is disposed below the bottommost gate line G_{E} on the lower side of the screen of the liquid crystal display device, and that at least one dummy pixel is located on the lower side of the individual peripheral pixels, as shown in FIG. 4. With this configuration, even if the scanning direction of the gate lines G is from the lower to the upper side of the screen, a phenomenon of the bright line or the like caused by the specific pixels can be suppressed.

The above description is merely an example of the active matrix substrate of the present invention and the display device using the same, and the technical scope of the present invention is not limited to the above specific example. For instance, although the liquid crystal display device has been described above as a display device, the present invention also can be applied to any display device other than the liquid crystal display device as long as it is an active matrix display device.

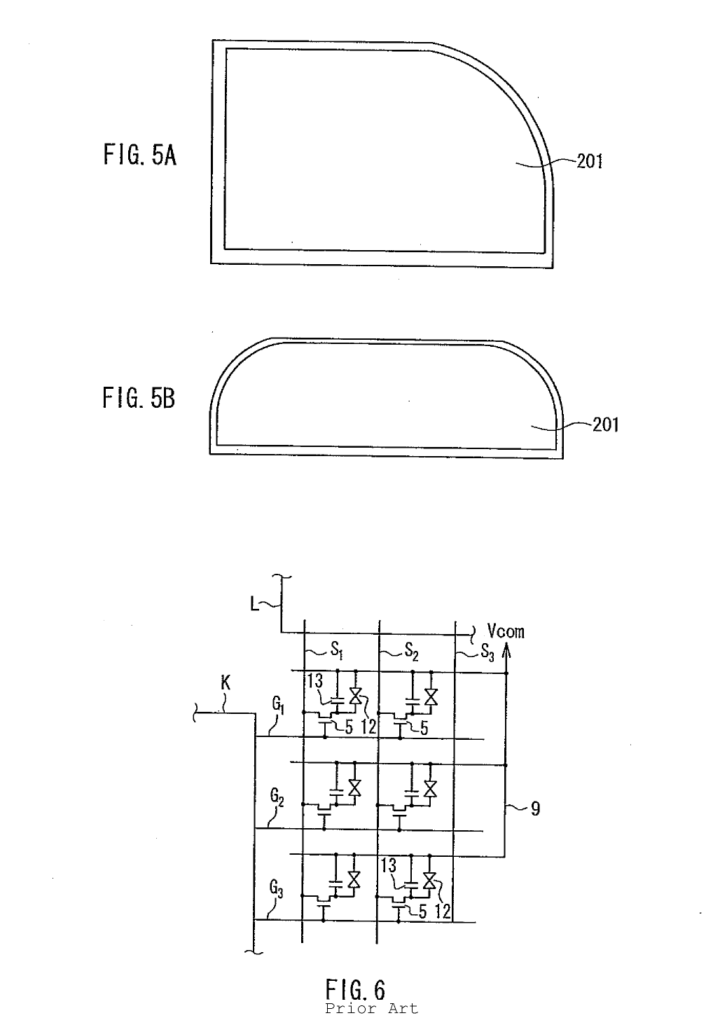

The shape of the display device is not limited to a circular or substantially circular shape as shown in FIG. 2, but may be semicircular or elliptic. Moreover, all the perimeter of the display area does not have to consist of curves. For example, as shown in FIGS. 5A and 5B, a display device in which a portion of the perimeter of the screen (display area) 201 consists of a straight line also is included in the technical scope of the display device of the present invention.

The present invention is preferably applicable to an active matrix substrate capable of preventing a defect such as a reduction in the display quality due to the bright line or the like caused by the pixels that are located in a specific portion, even in the case of an odd-shaped display. Further, the present invention also is preferably applicable to an active matrix display device capable of displaying high quality images by using the active matrix substrate.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12. An active matrix substrate comprising:
a plurality of gate lines to which scanning signals are applied;
a plurality of source lines to which data signals are applied, the source lines being disposed at right angles to the gate lines;
switching elements that are located in the vicinity of individual intersections of the gate lines and the source lines where each of the switching elements is connected to both the gate line and the source line; and
pixel electrodes that are connected to the switching elements; wherein
a distribution area of the pixel electrodes corresponding to a display area of the display device has a shape other than rectangular;
at least one dummy gate line is located outside the gate line that is located at an outermost edge on a scanning start side of the gate lines in the distribution area; and
among peripheral pixels located on a perimeter of the distribution area, when the gate line that is located at an outermost edge on the scanning start side of the gate lines is identified as a first gate line, the peripheral pixel connected to the nth gate line, where n is an integer of 2 or more, is interposed between the nth gate line and the (n−1)th gate line that is extended on an opposite side of the peripheral pixel from the gate line to which the switching element of the peripheral pixel is connected.

13. The active matrix substrate according to claim 12, wherein dummy pixels are provided outside the dummy gate line, and each of the dummy pixels comprises at least a switching element connected to the dummy gate line and a pixel electrode connected to the switching element.

14. The active matrix substrate according to claim 13, wherein a dummy gate line is further provided outside the dummy pixels.

15. A display device comprising the active matrix substrate according to claim 12.

16. The display device according to claim 15, further comprising a gate driver arranged to apply signals to the gate lines and the dummy gate lines.

17. The display device according to claim 16, wherein the signals input to the dummy gate lines by the gate driver differ from those to be applied to each of the gate lines.

18. The display device according to claim 17, wherein the signals input to the dummy gate lines by the gate driver have a voltage level at which the switching elements are not turned on.

19. The display device according to claim 17, wherein the signals input to the dummy gate lines by the gate driver have the same voltage level as scanning signals to be applied to each of the gate lines, and are applied to the dummy gate lines a predetermined time earlier than the scanning signal to be applied to the gate line that is located at the outermost edge on the scanning start side of the gate lines.

20. The display device according to claim 15, wherein the dummy gate lines are connected to any of the gate lines.

21. The display device according to claim 20, wherein the dummy gate lines are connected to the gate line that is located at the outermost edge on the scanning start side or the gate line that is located at the outermost edge on the scanning end side of the gate lines.

22. The display device according to claim 15, further comprising a counter substrate that is located opposite to the active matrix substrate and provided with a common electrode, wherein the dummy gate lines are connected to a common line to apply a common signal to the common electrode.
